(19) United States
(12) Patent Application Publication
(10) Pub. No.: US 2020/0304474 A1
(43) Pub. Date: Sep. 24, 2020

(54) METHOD AND SYSTEM FOR SECURE COMMUNICATION

(71) Applicant: Aaron Kisko, Kanata (CA)

(72) Inventor: Aaron Kisko, Kanata (CA)

(21) Appl. No.: 16/825,048

(22) Filed: Mar. 20, 2020

Related U.S. Application Data
(60) Provisional application No. 62/821,567, filed on Mar. 21, 2019.
(60) Provisional application No. 62/852,645, filed on May 24, 2019.

(51) Int. Cl. H04L 29/06; H04L 9/06

(52) U.S. Cl. CPC H04L 63/0421; H04L 9/0637; G06Q 30/0246; H04L 63/0272; H04L 63/0823

(57) ABSTRACT

A method and system for secure and private communication within a network having a first secure communication layer and a second communication layer with a filtering tunnel between which acts as a barrier and tether for enabling limited and secure communication of selected information between the two layers. The first secure communication layer comprises private user information and is connected to a first secure communication channel connected with the network, and the second communication layer comprises public user information and is connected with a second communication channel which is connected with the network. The filtering tunnel between the first secure communication layer and the second communication layer supports limited and secure communication of selected information between the first secure communication layer and the second communication layer.

### CROSS-REFERENCE TO RELATED APPLICATIONS

This application claims priority to U.S. provisional patent applications U.S. 62/821,567 filed 21 Mar. 2019 and U.S. 62/852,645 filed 24 May 2019, the contents of which are hereby incorporated by reference herein in their entirety.

### FIELD OF THE INVENTION

The invention relates to communication and more particularly to secure communication via a network or within the World Wide Web. This invention also relates to a method and system for secure communication having multiple communication layers with a filtering tunnel between for enabling limited and secure communication of selected information between the layers.

### BACKGROUND

The World Wide Web (WWW) comprises a large number of interconnected computers that communicate one with another according to a protocol. A common method of retrieving information from the WWW involves using a web browser to surf the WWW. A web browser allows information to be retrieved from web sites, addresses within the WWW, and to be displayed according to known protocols. The widespread use and adoption of the WWW is astonishing with people from all over the world communicating, sharing, doing business, and staying connected via the WWW.

A web browser is a software application that relies on known protocols to retrieve data from the WWW and to display information based on the retrieved data. Since web browsers adhere to standards, there are also numerous other web browsers and even open source software for web browsing. Typically, in accordance with the standards, a request for information is transmitted from a user system with an address of the user system. A reply to the request with the information is then transmitted to the user system for processing and display. Thus, a system that supplies data to a user system is usually aware of the user system address, which correlates to locations and other information about the user.

Common web browsers support cookies. Cookies are data that is stored locally on a user system for use by another system. For example, a cookie might store your progress in filling a shopping cart or your recent page views. Quite commonly, cookies are used to customise information for a user of a user system. For example, a cookie can indicate if a user has visited a particular web site before, allowing for customised advertisements relying on cookies. Also, cookies are useful in paying referral fees where a cookie indicates how you got to a commercial site allowing for payment of commissions.

A search engine is a particular tool that is used to find web sites within the WWW. A search engine, most often, scans the WWW in advance and builds an index to help speed up searching. Some search engines act to aggregate results from several search engines, relying on other search engines to perform the indexing. In effect, most search engines are quite basic in their configuration. A user enters a term or two to be searched and the search engine returns a list of web sites that are related to the entered term(s). Often, the search engine also displays advertisements to the user. Social media and other user content driven platforms rely on user generated content to generate traffic and revenue. The results of this are massive datacenters full of not only the content, but large consolidation of user private information, and profiles of all viewers of the content to be used to generate advertising revenue. This model has led to many questions of who owns a users' content and personal details, and has led to numerous abuses of this information.

In the early days of the Internet, advertisements seemed innocuous and sometimes even helpful. As the WWW ages, advertising is becoming more sophisticated and is relying on ever more personal data, both more data that is personal and data that is more personal. With the use of tracking software, cookies, and shared data, web sites that display advertisements, are seeking to gather as much personal information as possible. This leads to privacy concerns in relation to release of data relating to online activities as well as demographic information. For some, these privacy concerns are significant enough and result in a desire to control their information and privacy. To this end, there are a plurality of methods of anonymising a user's access to the WWW. These include privacy protected browsing, virtual private networks (VPN), TOR based communication, and trusted privacy protecting web sites.

In privacy protected browsing, a browser is set to erase all history and other data relating to a session, once the session is ended. In this way, for example, using a public computer at a public library leaves no footprints in relation to what was accessed on the computer that was used. Of course, the internet access server and other WWW sites may know what data was accessed and at what time, but without data on the library computer, it is difficult if not impossible to match this data to a user unless the user specifically provided their information. Unfortunately, such a methodology is ill suited to a private computer; matching data to the computer is possible, otherwise all the convenience and benefits of using one's own computer, cookies and browser history, are lost.

Relying on a virtual private network (VPN) allows a user to obfuscate their location. VPNs connect a user to the Internet via a secure tunnel. The termination of the secure tunnel at some point in the network allows user location and user system information to remain obfuscated. In this way, the end point within the Internet can determine a collective source at an end of the Tunnel within the Internet instead of at an Internet service provider (ISP) or a user IP address. Unfortunately, a VPN does not protect a user with regards to cookies and sharing of personal information, providing protection mostly against location identification. Further, a VPN itself may fail to anonymize information and, as such, is effectively a non-local ISP, or an ISP without geographic constraints. To get around this issue, a VPN may offer several tunnel end points allowing a user to choose and modify their access point on the WWW.

TOR-based communication involves routing traffic through a series of servers that are randomly selected and other than centrally managed so that it is nearly impossible to reverse traffic from source to destination. The use of TOR routing eliminates structure for a centralised network maintaining records and, therefore, prevents selling private routing data. TOR browsing typically results in different routing each and every time it is used, so correlation between different Internet communication sessions is difficult. Thus, it is preferred by some people. That said, the TOR architecture is slower than some other communication architectures and does not protect against user self-reporting or cookies.

It would be advantageous to protect user privacy without requiring the user to engage in complex behaviours. It would also be advantageous to protect user privacy without requiring the user to change their present WWW browsing behaviours. It would also be advantageous for a user to have identity, access and policy controls built directly into a browser with the ability to access multiple Domain Name System (DNS), IP and Blockchain networks from a single access interface.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and system for secure communication in a network having a first secure communication layer and a second communication layer with a filtering tunnel between for enabling limited and secure communication of selected information between the two layers.

In an aspect there is provided a system for private communication in a network comprising: a first secure communication layer comprising private user information; a first secure communication channel connecting the first secure communication layer with the network; a second communication layer comprising public user information; a second communication channel connecting the second communication layer with the network; and a filtering tunnel between the first secure communication layer and the second communication layer supporting limited and secure communication of selected information between the first secure communication layer and the second communication layer, wherein the second communication layer has a security setting lower than the security setting of the first secure communication layer.

In an embodiment, the private user information in the first secure communication channel is anonymized by the filtering tunnel during communication of data from the first secure communication layer to the second communication layer.

In another embodiment, the private user information comprises one or more of user identity data, access controls, cryptographic data, cryptographic algorithms, smartcard, policy settings, authentication features, peer to peer communication, email, messages video, text, and other forms of communication between users.

In another embodiment, the public user information comprises one or more of user IP address, cookies, trackers, public user profile, and other public information.

In another embodiment, the first secure communication layer comprises a cryptographic interface.

In another embodiment, each of the first secure communication layer and second communication layer has its own set of security policies and security settings.

In another embodiment, the first communication channel comprises connections to multiple networks having varying privacy and security requirements.

In another embodiment, the private user information comprises one or more user verified certificate, each user verified certificate comprising complete or partial user information.

In another embodiment, the first secure communication layer comprises one or more user verified certificate for a trusted site on the network, the user verified certificate comprising selected private user information required by the trusted site.

In another aspect there is provided a method of secure communication with a network comprising: establishing a first secure communication channel from a first secure communication layer comprising private user information to the network; establishing a second communication channel from a second communication layer comprising public user information to the network; anonymizing the private user information and transferring the anonymized private user information from the first secure communication channel to the second communication layer through a filtering tunnel; sharing the anonymized private information with a site in the network through the second communication channel; and receiving public information from the network via the second communication channel, wherein the second communication layer has a security setting lower than the security setting of the first secure communication layer.

In another embodiment, the method further comprises sharing private user information with a secure site on the network from the first secure communication layer through the first secure communication channel.

In another embodiment, the first secure communication channel communicates with the network through one or more of DNS, IP, blockchain, and other routing and directory services.

In another embodiment, the anonymized private user information is used by the second communication layer to retrieve the received public information, the public information comprising information targeted to the user based on the public user information.

In another embodiment, the private user information comprises one or more of user identity data, access controls, cryptographic data, cryptographic algorithms, smartcard, policy settings, authentication features, peer to peer communication, email, messages video, text, and other forms of communication between users.

In another embodiment, the first secure communication channel uses at least one of a VPN, TOR, a trusted anonymizing web site, and privacy and policy settings.

In another embodiment, the public information comprises user-targeted information based on the public user information. In another embodiment, the user-targeted information comprises one or more of advertising information, and custom content. In another embodiment, the method further comprises reporting the advertising information to the advertiser for tracking and invoicing of advertising performance and revenue.

In another embodiment, the method further comprises accessing multiple applications simultaneously and separating data streams in secure and unsecure dataflow for the multiple applications while running simultaneously.

In another embodiment, the method further comprises providing a user verified certificate to a trusted site through the first secure communication channel, the user verified certificate comprising selected private user information required by the trusted site.

In another aspect there is provided a method comprising: establishing a first communication channel from a first system to a second other system via a wide area network, the first communication channel anonymized for protecting some privacy of a first user of the first system; browsing the World Wide Web via the first communication channel; establishing a second other communication channel from the first system communicating partially anonymized information about the user of the first system via the second other communication channel; providing privacy protecting communication within the first system between the first communication channel and the second other communication channel; and receiving second information via the second channel for providing to the user of the first system and for display with information displayed while browsing the World Wide Web.

In an embodiment, the first data comprises web usage data.

In another embodiment the protecting some privacy comprises using at least one of a VPN, TOR, and a trusted anonymizing web site within the first communication channel.

In another embodiment the information about the user of the first system comprises anonymized information about the user for use in retrieving the second information, the second information comprising user targeted information to the user.

In another embodiment the user targeted information comprises advertising information. In another embodiment the method further comprises reporting the advertising information to the advertiser for tracking and invoicing of advertising performance and revenue.

In another embodiment the method further comprises using information provided via the second channel for delivering advertising content to the first system in relation to demographic data of the user.

In another embodiment the method further comprises using information provided via the second channel for delivering advertising content to the first system in relation to content provided via the first communication channel.

In another embodiment the method further comprises using information provided via the second channel for delivering custom content to the first system via the first communication channel, the custom content customised based on the information.

In another embodiment the first communication layer contains full or partial user identity information, access controls, policy information and other methods to ensure a first user meets certain criteria to access the second system or user

In some embodiments the user can use their identity, access controls and policies to access multiple DNS, IP or blockchain networks with varying degrees of access requirements and privacy settings.

In another embodiment with the user controlled aspects of the platform a user can host their own content in the method of their choice and control how that content is access using the controls and policies of the first layer.

In some embodiments a user can use the communication abilities of the first layer to send updates to other users.

In another embodiment the second communication channel comprises communication with a trusted broker for brokering information retrieved via the second communication channel.

In accordance with another aspect of the invention there is provided a method of communication comprising: establishing a first communication channel from a first system associated with a first user to a second other system via a wide area network, the first communication channel protecting at least some privacy of the first user of the first system; accessing first data via the Internet via the first communication channel; establishing a second other communication channel from the first system to the second other system and communicating information about the user of the first system via the second other communication channel; and providing privacy protecting communication within the first system between the first communication channel and the second other communication channel.

In an embodiment the first data comprises web browsing data.

In another embodiment the protecting at least some privacy comprises using at least one of a VPN, TOR, and a trusted anonymizing web site within the first communication channel.

In another embodiment the information about the user of the first system comprises anonymized information about the user for use in retrieving second information, the second information comprising user targeted information to the user.

In another embodiment the user targeted information comprises advertising information.

In another embodiment the method further comprises reporting the advertising content to the advertiser for tracking and invoicing of advertising performance and revenue.

In another embodiment the method further comprises using information provided via the second channel for delivering advertising content to the first system in relation to demographic data of the user.

In another embodiment the method further comprises using information provided via the second channel for delivering advertising content to the first system in relation to content provided via the first communication channel.

In another embodiment the method further comprises using information provided via the second channel for delivering custom content to the first system via the first communication channel, the custom content customised based on the information.

In some embodiments the filtering tunnel comprises a cryptographic interface between the first communication layer and the second communication layer.

In some embodiments a the second system can be accessed through independent networks using DNS, IP or multiple blockchain networks

In accordance with another aspect of the invention there is provided a system for communication comprising: a first communication layer for providing communication having a first privacy level; a second communication layer for providing communication having a second other privacy level; and a filtering tunnel for providing privacy protecting communication within the system between the first communication layer and the second other communication layer, the first communication layer for communicating via the Internet and the second communication for communicating via the Internet, independent of the first communication layer.

### BRIEF DESCRIPTION OF THE FIGURES

Exemplary embodiments of the invention will now be described in conjunction with the following drawings, wherein similar reference numerals denote similar elements throughout the several views, in which:

FIG. 1 is a diagram of a computer system;

FIG. 2 is a network diagram of a computer system in a wide area network;

FIG. 3 is a diagram of a secure setup relying on two separate computer systems;

FIG. 4 is a diagram of a computer system supporting two separate layers;

FIG. 5 is a diagram showing communication layers within a computer system;

FIG. 6 is a diagram of components of an identity verification process in the first secure communication layer;

FIG. 7 is a diagram showing components of the second unsecure communication layer;

FIG. 8 is a diagram of the first and second communication layers bound with a filtering tunnel;

FIG. 9 is a network diagram with different communication layers within the network;

FIG. 10 is a network diagram showing a computer system communicatively coupled to a wide area network and a server;

FIG. 11 is a network diagram showing a computer system communicatively coupled to a wide area network and a cloud service in the form of cloud storage;

FIG. 12 is a network diagram of an embodiment supporting Internet of Things devices;

FIG. 13 is a diagram of multiple devices sharing a single profile;

FIG. 14 is a diagram illustrating a peer to peer interaction via an encrypted camera;

FIG. 15 is a diagram illustrating contacts and groups management in a secure communication layer across multiple networks;

FIG. 16 is a diagram illustrating a peer to multi-peer secure network;

FIG. 17 is a diagram illustrating a peer to peer communications using a blockchain routing system;

FIG. 18 is a diagram illustrating a parental control with a user cloud profile identifying a family device pool;

FIG. 19 is a diagram illustrating a parental control profile governing a child profile;

FIG. 20 is a diagram illustrating secure contact between youth on an online platform;

FIG. 21 is a diagram illustrating a process of securely accessing a website for the first secure communication layer using a smartcard and credentials;

FIG. 22 is a diagram of the creation and distribution of a post in a self-hosted social media or content page;

FIG. 23 is a view of a post feed containing headers from multiple contacts;

FIG. 24 is a diagram of a network multi-web; and

FIG. 25 is a view of the connection to multiple networks from the first communication layer.

### DETAILED DESCRIPTION OF THE INVENTION

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

### Definitions

World Wide Web: The World Wide Web (WWW), or simply the ‘web’, comprises a large number of interconnected computers that communicate one with another according to a protocol.

Internet: The Internet is another term for the communication infrastructure and communication protocols of the World Wide Web and is sometimes used as a synonym for the WWW.

Browser: A browser or a web browser is a software application that relies on known protocols to retrieve data from the WWW and to display information based on the retrieved data.

Surfing the Web is a term referring to using a web browser to retrieve data from the WWW and to display information based on the retrieved data.

TOR is a communication architecture for enhancing anonymous communication. The TOR architecture directs traffic through a worldwide, volunteer overlay network presently having more than 1000 relays, thereby concealing a user's usage and location making it difficult or impossible to conduct network surveillance or traffic analysis.

Virtual Private Network (VPN): A virtual private network is a private network formed using public communication infrastructure. Encryption is relied upon between communication endpoints to maintain the privacy of the network.

Internet Service Provider (ISP): An ISP is a provider of Internet services and is typically a service or communication provider to which users connect in order to communicatively couple with the Internet.

Tunnel: A tunnel is a communication path formed between endpoints wherein information between the endpoints is secured such that unsecured information provided at one end point is only available unsecured at the other end point of the “tunnel” and not therebetween. The filtering tunnel described acts as both a tether to connect a first secure communication layer to a second communication layer, and also as a barrier to control flow of data between the layers. The filtering tunnel connects the first and second communication layers restricting the flow of personal and private data and allowing policy and setting information to be transmitted. These settings ensure that only appropriate content will be shown in the second layer.

Trusted privacy protecting web sites: Trusted privacy protecting web sites, also referred to as trusted sites, are WWW services that are provided to end users under an agreement to protect each user's privacy. Trusted privacy protecting websites are typically a result of user communities building trust in a particular WWW site or service provider.

Herein is provided a method and system for secure communication between users in a network having a first communication layer and a second communication layer with a filtering tunnel which serves as a tether or barrier between for enabling limited and secure communication of selected information between the two layers. Also provided is a method and system for secure communication between users in multiple networks of varying privacy and security requirements having a first communication and a second communication layer with a filtering tunnel which acts as a tether or barrier between enable limited and secure communication of selected information between the two layers. The first communication layer provides secure and browsing and communications and contains user identity, access controls and cryptographic and authentication features. The second communication layer provides a limitedly filtered or unfiltered dataflow allowing advertising and unsecured information to be transmitted without being affected by the content and actions of the first communication layer.

The service filtering tunnel serves enables multiple applications to run simultaneously and provides a secure layered browsing platform that separates data streams for secure and unsecure dataflows while running simultaneously. The present method and system provides an application of a private browsing platform for web browsing, web based applications or other standalone applications, using a segregated approach to separate the advertise and tracking from the web browsing or application experience. This method will allow a user's privacy to be maintained while simultaneously allowing for content creators to be compensated through cookie and IP address based advertising services.

The running of applications and viewing the web through the present system improves user privacy via the first secure communication layer while retaining the ability of advertisers to generate passive income through standard and targeted advertising delivery via the second communication layer. In this way advertisers can run separately without the ability to gain additional information from the user in secure mode. The service filtering tunnel acts as a tether or barrier allows multiple applications or dataflows to run simultaneously or alone while limiting the communication between the two. The first communication layer provides secure and browsing and communications and contains user identity, access controls and cryptographic and authentication features. The second communication layer provides an unfiltered dataflow allowing advertising and unsecured information to be transmitted without being affected by the content and actions of the first communication layer.

When a user browses websites without the application, the cookie and advertising profile in their system will continue to develop to give the platform access to a greater and changing advertising profile. In one example, when visiting a government, financial or other site where the owners of the content do not want advertising displayed, the site policy and content creator identifier can close the filtering tunnel and turn off the second layer containing non-essential information such as advertising. In another example, a content for revenue site can enforce their advertising policy through the filtering tunnel to the second layer and generate revenue through the advertising through a separate system while a user views their content anonymously. The presently described segregation will bring a more balanced approach to user privacy versus revenue.

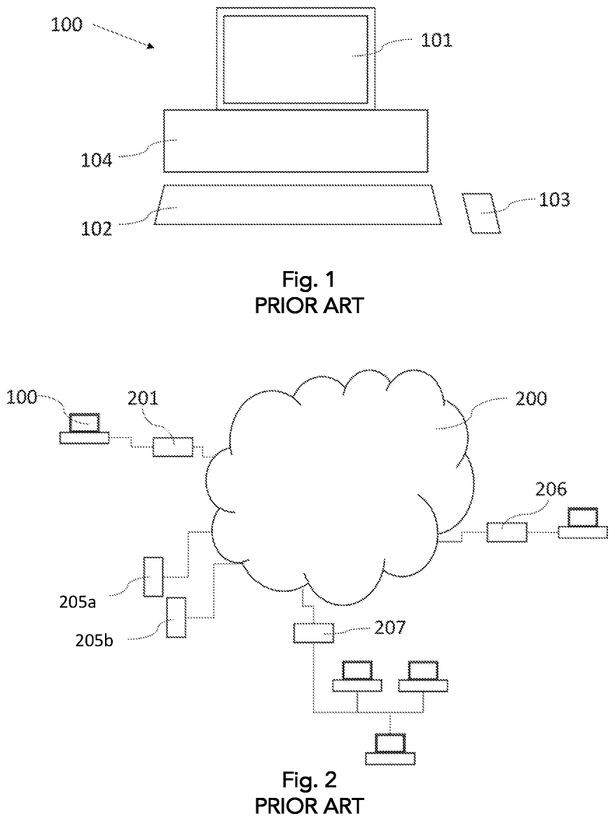

FIG. 1 shows a PRIOR ART computer system 100. The computer system 100 comprises a monitor 101, a keyboard 102, a mouse 103, and a processing unit 104. Typical processing units comprise non-volatile memory, volatile memory, communications circuitry and a processor. It is well understood how a computer system, whether specialized or general purpose, is used for communication. Typically, such a system comprises a communication stack via which all communication is routed. In such a fashion, all communication via the communication port is routed via a system communication stack. It is understood that computer systems on which the present method and system can be employed can be similar to computer systems shown in FIG. 1, or could optionally have alternative input devices other than a keyboard and mouse, including but not limited to one or more touch screen, haptic device, optical sensor, sound sensor, or other Internet of Things (IoT) enabled input device. Alternative output devices other than a monitor can also be employed such as but not limited to auditory or sound emission devices, haptic feedback devices, or other IoT enabled output devices.

Referring to FIG. 2, shown is a PRIOR ART computer communication network with a computer system and a wide area network in the form of Internet 200. Computer system 100 is coupled via a communication port thereon to a service provider 201. The service provider 201 provides access to a wide area network in the form of the Internet 200. Communicatively coupled to the Internet 200 are other systems including computer systems similar to computer system 100, servers 205a/205b, firewalls 206 and gateways 207. Firewalls 206 and Gateways 207 serve to isolate private networks from the Internet 200.

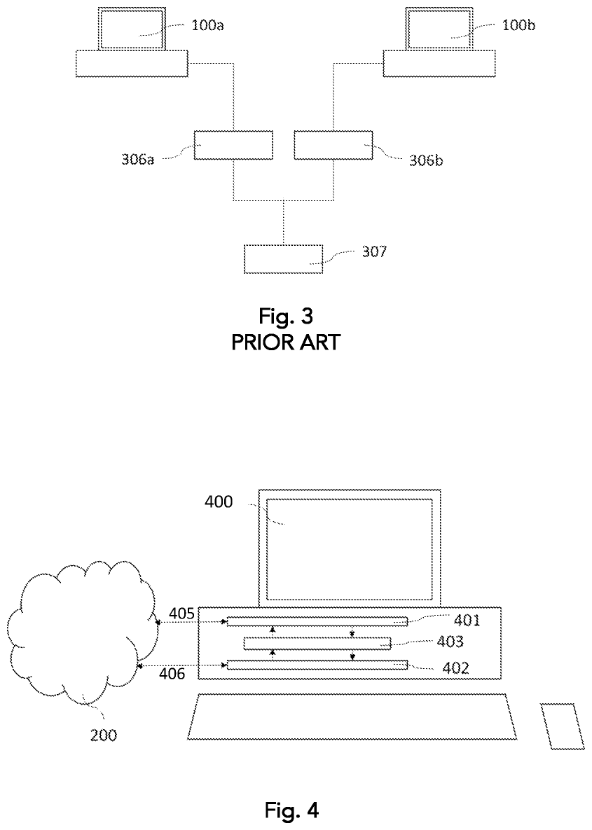

Referring to FIG. 3, shown is a PRIOR ART communication architecture for computer systems such as the computer system 100 of FIG. 1. The architecture provides a first computer 100a with a secure communication layer for secure communication via a communication port with firewall 306a and then via gateway 307 to the Internet. A second computer system 100b having a communication layer supports a public communication layer for communication via a communication port to firewall 306b and then via gateway 307 to the Internet. Between the first system and the second system is no communicative coupling for preventing communications therebetween. In use, the architecture of FIG. 3 allows for secure communication from the first computer system 100a and unsecure communication from the second computer system 100b. The two forms of communication are separate and information from one layer can only be transported to the other layer by the user physically transferring information with intention. Therefore, security is maintained for secure communications so long as the people involved do not choose to breach security. Such an architecture is considered highly inconvenient as often times unsecure information is intended for routing to both secure and unsecure destinations. For example, when using an electronic mail software package for secure ‘encrypted’ communication on computer system 100a and another electronic mail software package for unsecure plain text communication on computer system 100b, it is easy to see how a message might be intended for secure and unsecure recipients. This requires generating the message twice, once on each computer system. Alternatively, secure contacts are also available on the unsecure computer system 100b, which may lead to human error security breaches. Finally, a user could copy the one message to both systems risking security breaches via the copying mechanism. When security is inconvenient, it can be problematic as users often cut corners for convenience. Conversely, the more automated security and therefore the more convenient, the more it is difficult to avoid contagion, such as when a group of contacts is divided into those for whom encryption is used and those for whom encryption is not used. When available, encryption is always used. When an electronic message is sent to a group of people including secure contacts and unsecure contacts, the way the message is treated matters a great deal. The content of the message is of concern, as for one-on-one communication security is always maintained when necessary, but for group messages one member of the group lacking encryption results in the message being transmitted insecurely. So, making security a background transparent process makes it less likely that every user will consider the effects of communicating to groups.

Referring to FIG. 4, shown is a communication architecture for a computer system in the form of the computer system 400 supporting two communication separate layers, one first layer which is more secure and one second layer which is less secure, having a filtering tunnel therebetween. This architecture provides a secure first communication layer 401 for secure communication via a communication port and via the Internet 200. A second communication layer 402 forms a public communication layer for communication via a communication port and via the Internet 200. Between the first layer and the second layer is a filtering tunnel 403 for filtering communications therebetween. In use, the architecture of FIG. 4 allows for a level of secure communication from the first communication layer and unsecure communication from the second communication layer but supports communication between the first and second communication layers to allow for synchronising between secure and unsecure communications. It is understood that the present system can comprise more than one secure first communication layer and/or more than one second less secure communication layer in the same system. It is also understood that the present system can comprise more than one secure first communication channel and/or more than one second less secure communication channel in the same system.

For privacy applications, such an architecture has significant advantages. A user of a system employing the architecture of FIG. 4 communicates with the network via the secure communication channel 405 maintaining privacy through any of a number of privacy-protecting models in the form of a tunnel, a trusted service provider, a VPN, or a TOR based browsing model. Thus, the user privacy is protected and optionally further security is employed. In parallel, the same computer system communicates from the second communication layer 402 via the unsecure communication channel 406 public information the user requires for convenience, is comfortable sharing, or that is already public. In some embodiments, this public information can include anonymized personal demographic data. Alternatively, the public information can includes user specific criteria. In practice, anonymizing data refers to restricting, removing, or obfuscating private user information while retaining public user information that is acceptable by the policy for public sharing and/or dissemination. In many cases, the anonymizing of private user information can result in anonymized information that is different depending on the privacy requirements of the external network being accessed or shared with.

For example, a user with no public demographic data indicates that they are looking for a luxury car. This allows advertisers to advertise to the user in a fashion consistent with the user's goals without having to collect and assess personal information. In another embodiment, because sharing of information is under control of the secure communication layer, the present system is also supported to restrict access to private information based on a requestor of the private information. Cookie information is provided in response to some requests and not others. Similarly, data is filtered in accordance with information received from the secure communication layer. User configuration options or preconfigured security settings regulate the level of information being released and to whom. Of course, once information is released, it often becomes public—it is impossible to un-tell a secret, so in some embodiments release of information is on a purely need to know basis. In another example, Amazon® receives the shopping cart information but an advertiser might only receive a filtered set of shopping cart contents in order to support advertising of competing or complimentary items. Alternatively, an advertiser receives a list of competing and complimentary items. Thus, the system allows for different methods of use providing flexibility. In an alternative configuration, some communication is provided via an unsecure communication channel. For example, this can be achieved by transferring communication requests from the secure communication layer to the insecure communication layer automatically, such as when the destination is not subject to security requirements. Web browsing is effectively unsecure and only as private as a user maintains. Such a configuration supports all present web browsing activities as it is effectively equivalent thereto. This allows for online shopping, video streaming services, and other services that do not truly support privacy or that require superior performance.

In another configuration, some web sites are accessed via the unsecure channel of communication while others are automatically handled via the secure channel of communication. Since the filtering tunnel allows for communication between layers, the transfer of requests from the unsecure side of the filtering tunnel to the secure side of the filtering tunnel is supported. When a request is handled by the secure side of the filtering tunnel, privacy is enforced so that tracking of personal data is prevented or limited. Here, for example, work related online services are routed via the secure side of the filtering tunnel to the enterprise server at work and from there to a destination. Thus, work maintains security through a tunnel and through monitoring, filtering, and logging of work. Further, all tunnels between work and other endpoints are maintained and other than bypassed. At the same time, viewing a streaming video can be handled on the unsecure side of the filtering tunnel while work is maintained by the secure communication layer. Further, other communication, such as with a bank or for anonymous browsing is handled from the secure side of the filtering tunnel.

In other embodiments, a user can stream video securely due to its contents or origin. In those situations, the user or streaming provider is still capable of monetizing the video streaming via advertising. For example, a video provided to “friends” on a social network is streamable to “friends” without public dissemination and still supporting advertising content. In yet another configuration, some web sites can be accessed via the unsecure channel of communication while others are handled via the secure channel of communication with unsecure channels providing some data for use during secure channel communication. Since the filtering tunnel allows for communication between layers, the requests from the unsecure side of the filtering tunnel can be used to transmit data from the unsecure side of the filtering tunnel. Thus, a response to a search request made anonymously can be displayed with advertisements returned via a TOR architecture and based on reported demographic or interest data from the user of the secure channel. The advertisements are based on data that is retrieved from the unsecure side of the filtering tunnel and potentially transmitted therefrom.

The presence of a filtering tunnel between in the system architecture provides numerous advantages. Firstly, each private aspect of each transaction is decoupled and secured. For very sparse services, services being requested a few times a day in total, decoupling is of limited benefit. However, for services such as Google® search, where searching is requested many times each day, decoupling a search request from an associated advertising request, such as a request for user information and user demographics, uncouples the accessing of private user information from public user information. This in turn uncouples the datasets in each of the secure communication layer and the second public communication layer. Search results based solely on keywords is still supported should advertising be so limited. Further demographic data is providable either with the keywords or decoupled therefrom but decoupled from the actual response. Further decoupling, for example providing advertisements from a different service than the search service, allows different information to be provided to each service which separates the search request and the advertising data. In such an example, a search engine might receive no demographic data unless required to disambiguate. This occurs when, for example, a user uses terms that require disclosure, such as “near me.” The use of the secure channel and the filtering tunnel also allows a user to specify their level of acceptable interaction and sharing in order to limit privacy issues and even allows for filtering of advertisements should a user so desire. However, cookies and other information trackers that get installed in the unsecure side of the filtering tunnel will still operate and will still provide data to their respective servers. This allows (a) for continued use of existing servers and services, (b) a continuation of expected responses from servers and services where those servers and services currently operate, and (c) the services will continue to get paid for referrals, etc. should data be stored for this purpose.

Search request are thus supported in both the unsecure and the secure side of the filtering tunnel. When a request is handled by the secure side of the filtering tunnel, privacy is enforced so that tracking of personal data is prevented or limited. Here, for example, work related online searches can be routed via the secure side of the filtering tunnel. Thus, work maintains security and privacy. Optionally, the secure side of the filtering tunnel is separately password protected. At the same time, viewing a streaming video or non work-related activities can be handled on the unsecure side of the filtering tunnel. The filtering tunnel operates to protect work related material on the secure side while maintaining convenience. For example, an email with a work contact destination is automatically transferred to be sent from the secure side of the filtering tunnel. Alternatively, a user is prompted to transfer the email to the secure side of the filtering tunnel. Similarly, work from the unsecure side of the filtering tunnel can be incorporated into the secure side activities. In effect, the filtering tunnel allows for a set of policies and procedures to filter information to maintain two distinct communication channels, each with a different security level. As in the above embodiment, demographic data from the unsecure side of the filtering tunnel is releasable should that be in accordance with the configuration information. Thus work and work-related demographics are protectable while the individual's demographic data is shared, with permission, to allow for use of subscriptions, advertising, and other forms of monetization.

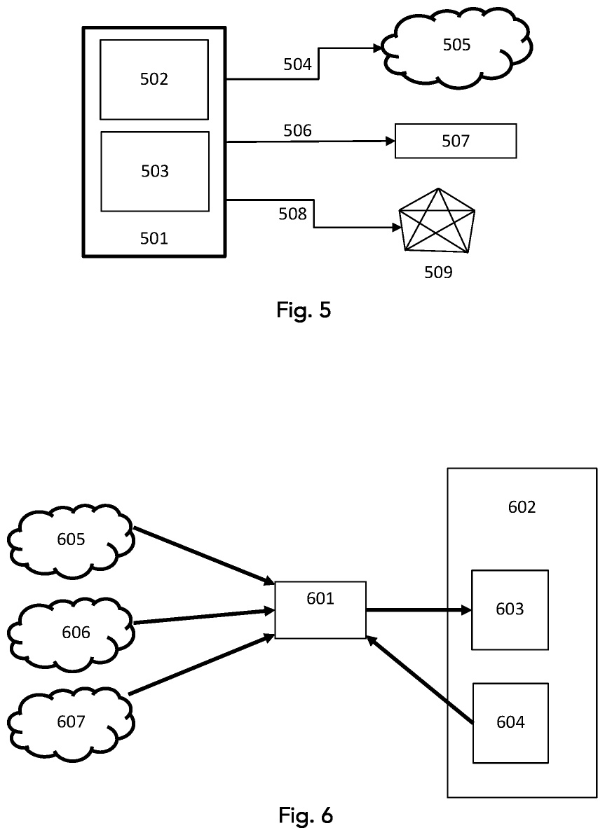

FIG. 5 is an architectural diagram showing communication layers within a computer system and a view of the components of the first communication layer 501. Within the secure first communication layer 501 are contained one or more secure elements 502 including one or more enhanced cryptographic algorithms, software or hardware smartcard, user profile and policy settings and other secure and security elements. Also included are one or more secure applications 503, including encrypted communications, collection of utilities, cloud access, routing, and peer to peer locating capabilities. Using the privacy enforcement in the secure layer, a private mode connection 504 provides a secure and private experience on the internet 505. In cases where a peer to peer connection is being made to other users or content the routing system, secure application 503 can find and create and peer to peer connection 506 to the other user or content in peer system 507. In other cases the desired content or user may be found through a blockchain system 508 such as a blockchain DNS system to content or user location 509.

Referring to FIG. 6, shown is a diagram outlining the user verified certificate service and the components of the identity verification process in the first secure communication layer. A certificate authority 601 can generate a user verified certificate with limited details on the user and load to the certificate store 603 in the first communication layer 602. Using the integration with a software or hardware smartcard 604, a registered certificate can be generated and bound to a user's device and installation. In one case a trusted third party service 605 could be used to verify the user. In other cases, an enterprise could choose to verify their employees through their own internal verification service 606. In another case a verification and certification generating system can be created to allow certain groups to self-verify, which would be especially useful for groups that lack valid photo identification for the identity verification. One such case would be, for example, schools where student may not have a valid photo ID, but are known to the administrators. In cases like this the school or schoolboard could function as a verification authority 607. This solution would provide superior protection of minor on the internet when used with the features of the invention.

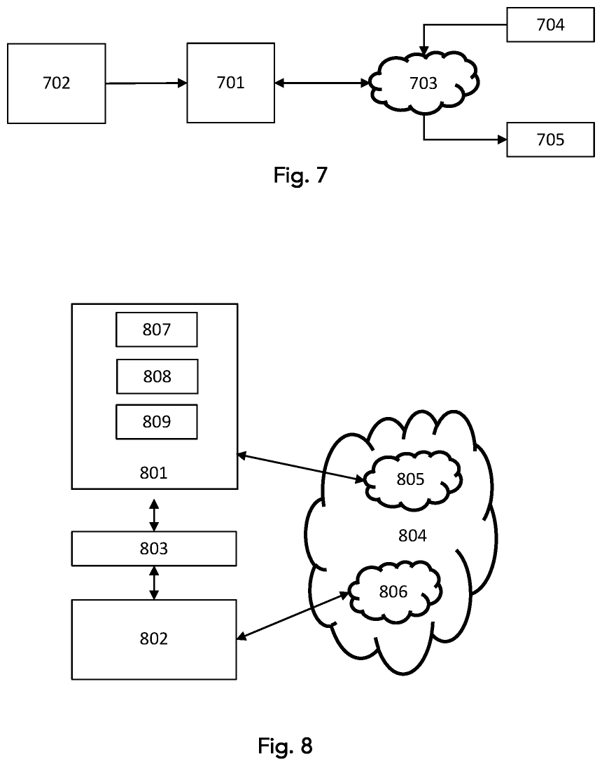

Referring to FIG. 7, shown is a view of an embodiment of the second communication layer. The second layer is the unsecured communication layer 701 primarily used for unsecure communication such as, for example but not limited to, advertising delivery and unsecured web browsing, and can be granted access to the user's IP address, cookies and any available system profile information 702. Advertising and other unsecured information access through the internet and advertising delivery service 703 pulling advertising from a collection of advertising sources 704 and distributing revenue to registered content creators 705.

Referring to FIG. 8, shown is a diagram of the first communication layer 801 and the second communication layer 802 connected through a service filtering tunnel 803. Communication to the internet 804 can be split between secure content 805 and unsecured content 806. Contained in the first communication layer 801 can be contact, access, identity security certificates 807, secure applications 808 and components, and user defined profiles and policies 809.

In some embodiments, applications connect to the wide area network via a secure link layer, in the form of the first secure communication layer, allowing for secure applications without a “new” or separate security layer. The first secure communication layer serves as a security layer and functions internal to a computer system within a network, within an enterprise, and for cloud/public facing servers and services. Applications operating with first secure communication layer can optionally be provided with advertising content for display, which can be delivered via the second unsecure communication layer communication channel. This allows applications to piggy back on the advertising communication channel that is already supported and to benefit from advertising revenue. The embodiments described hereinabove are compatible with private key-public key encryption. In such an embodiment, instead of relying on shared keys, asymmetric keys are relied upon for securing communication. Further, embodiments are capable of supporting policy-based actions. For example, supporting multi-group communication supports implementation of different requirements and/or policies for each group. Inter and Intra group policies are also supported. Therefore, sending a message to a group can follow the group policy. However, in some embodiments when a member of a group is a member of another group, a different policy can be implemented in accordance with the overlapping membership. For example, an interest group “computer vision” may be considered public for communications, however, within the group are three clients. When a message is transmitted to the group, a reminder can be presented that there are clients in the group before transmitting the message. Conversely, when a message is sent to a client within the policy of the group, the message can be automatically upgraded to a more secure communication protocol in view of the communication being with a client. Thus, without significant inconvenience, company policies in relation to client communications can be securely managed. Further, when a contact is not secure, communications, in some embodiments, are rerouted to a secure storage from which unsecure users can view communications in a secure fashion, for example being unable to save, print or forward. This method of communication is analogous to the method of posting to a social network, but for private message communication and for file sharing. In an alternative embodiment, all user communication such as SMS, message, voice, video, etc. can be transmitted along the secure channel of communication, thereby enhancing user privacy further. By restricting communication to the secure channel, privacy of user communication can be maintained while also maintaining user convenience. Further, said privacy can be applied as a function for all forms of communication.

In some embodiments, WWW sites enforce security by only operating via the first communication layer to enhance overall security. The presently described architecture also supports enhanced security such as only allowing secure websites via the secure channel and thereby limiting spoofing of secure web sites. Further, the enhanced security is enforceable locally on a user system providing enhanced user data for security purposes without affecting user privacy. Similarly, dating sites, classified sites, and social networks can enforce privacy, identity, and security via the secure channel or other than do so via the unsecure channel. Thus, some “friend” requests arrive from secure individuals, individuals who are identified, and others from unsecure individuals. This enhances traceability and security of interactions and transactions. Password management and autofill can also enabled by the identity verification component of the system.

The present security system is usable to filter as well as to secure data. For example, if a bank only works securely, no attempt at spoofing the bank with an unsecure channel functions. Similarly, SMS messages and friend requests from unknown contacts are blocked pending verification of identity, however that is performed. Finally, the secure channel supports multiple interfaces that each are useful locally to verify one another though outside of the local system are unknown one to another. In another embodiment, the method and system provides integrated identity management. On top of password management and autofill, the presently described platform can also be enabled to use a know your customer (KYC) type identity verification service to optionally verify a user's identity. Preferably, the KYC identity service is trusted and widely used, as well as secure. Other users will be able to know that the person they are communicating with has a known identity, and that that identity has been verified and can be discovered should the communication result in illegal activity. This verification can ensure that a user's name, location, age and other details have been verified without being stored by the system or shared with other platform users, and user personal data can be maintained separate from the platform itself. The system does not even need to know the verified details, relying instead on the fact that the identity is verified and retrievable on certain conditions. The verification ID can also be tied to a user account, and once an account has been marked as having a verified identity, an added layer of trust is applied to the associated account and therethrough with the associated user. In such an embodiment, an ability to block all communication with unverified users inherently limits scams and some forms of unsafe communication such as phishing. In practice, a user can be enabled to block all communication attempts from non-verified identities, for example with a return message to sender that this user only accepts messages form verified users whose identities have been afforded a trust designation by the system. Alternatively, the reply can provide other mechanisms for identifying a source of the communication.

In social media, comments and postings can also be filterable based on verified identification and unverifiable identification. Even amongst verified identification, filtering can be supported based on whether the identification is shared or not. Thus, the process allows for limiting posts and comments to verified identities or alternatively limiting posts that are viewed to those from verified identities. Verified identities are also useful in filtering messages for other applications including but not limited to classified ads, online dating, website access, financial information, reviews, comments, postings, responses, and other online communication platforms. Further, a verified identity allows for a verified digital signature to be added to some postings. Yet further, verified identity is also useful to provide verified personal information such as proof of age, proof of residency, proof of attendance at an institution, proof of employment, and so forth. Thus, without identifying an individual, the process ensures the relevance of a user to specific situation, whether it is age appropriateness or membership in a relevant group. Similar identity verification supports verification of institutions or other factors such as a clean driving record or money in the bank or investments in certain stocks, depending on the verification process that is in place.

The present system and method can also reduce phishing scams as accounts from scammers will not be verified and can be flagged as such, thereby increasing online safety to users. Further, any application from a classified ad to online dating to financial information to reviews and comment sections or requests can be stamped with a verified identity signature, providing an additional layer of verification that the third party advertiser or poster is verified without providing any identifying information on the user. In addition, the present system can provide proof of age required for any website that has age restricted content or requires age verification under the Children's Online Privacy Protection Act of 1998 (COPPA) without the requirement to obtain and store personal data. This provides a level of assurance for both platform and user that all parties are verified, legitimate, while protecting the parties by limiting exchange of personal data.

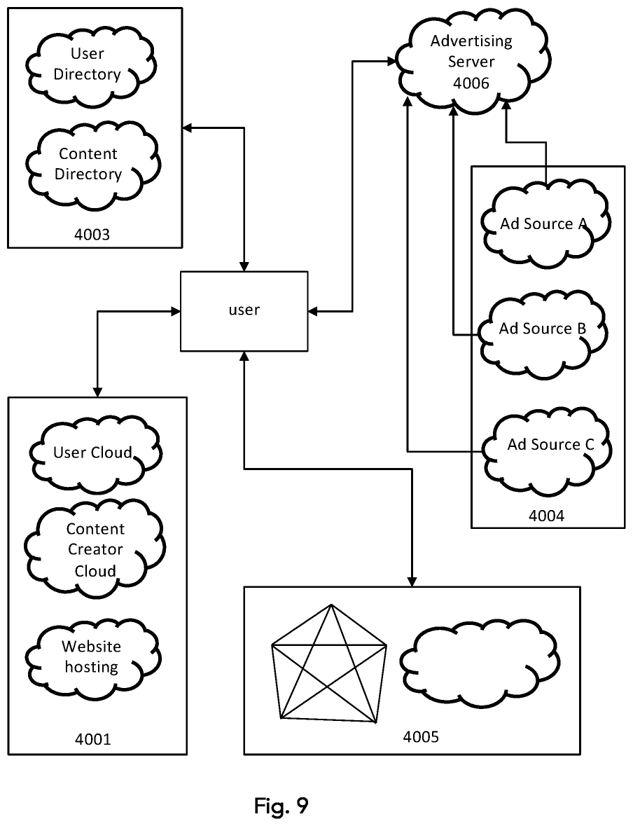

Referring to FIG. 9, shown is a network communication diagram for communicating with different external servers and services according to an embodiment. The first communication layer at the user site communicates securely with the Public servers 4003 comprising of one or more public opt-in directory systems. Blockchain and DNS routing system 4005 enabling peer to peer communication between users on the first layers. Collection of servers 4001 and associated services and applications contain user created content and storage. Bound with the filtering tunnel at the user site The second communication layer at the user site accesses the anonymizing advertising server 4006 allows for advertisements and demographic data to be provided to the advertising layer and from the advertising layer, respectively. The browsing activities occur in private fashion relying on a mechanism for privacy protection such as trusting the destination servers, relying on tunnels, relying on TOR, relying on a VPN, or simply not sharing any data beyond the URL request with the servers and service providers. On the advertising layer, further information such as demographic information and cookie data are shared either with a single trusted advertising server or broker (as shown) or with a plurality of advertising servers 4004. As well as any unsecured internet access.

In some embodiments, in the architecture of FIG. 8 and FIG. 9, a user is provided an opportunity to subscribe in order to opt out of advertising or in order to opt out of some advertising. The browser operating in the first secure communication layer is secure, and in some embodiments the browser includes one or more of the following: prevents screen shots; prevents saving data; does not track browser history; prevents entry of some personal information; and blocks malware, viruses, cookies, etc. In other embodiments, a contact creator may opt out of advertising being displayed while their content is being viewed by a user. In this case with or without a subscription the second communication layer would be disabled. In one example, when a user clicks through on an advertisement, the corresponding web site can be brought up within a browser window communicating via the unsecure second communication layer. Alternatively, the corresponding web site is brought up within a browser window communicating via the secure first communication layer.

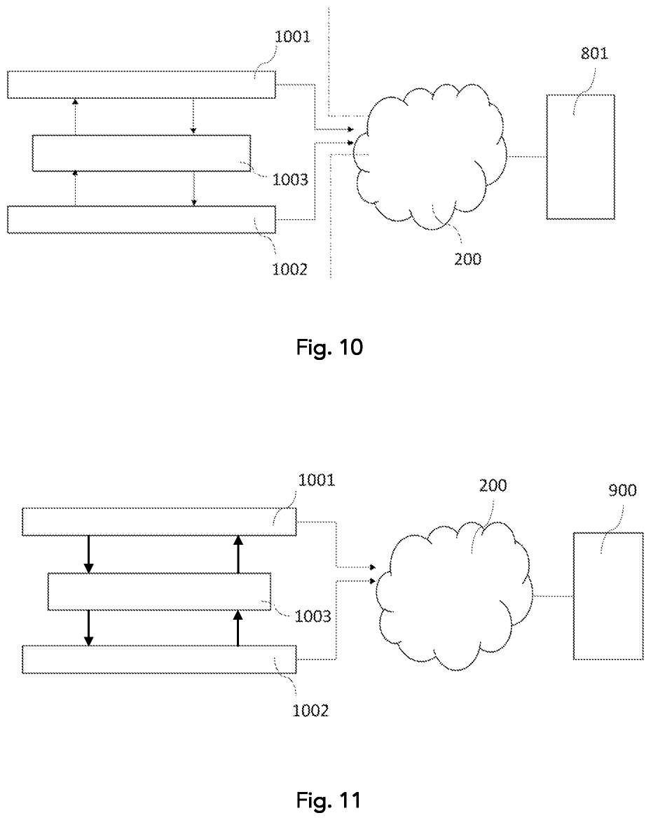

Referring to FIG. 10, shown is a view of another embodiment wherein a service is offered only for use with an embodiment of the present invention. Here, a server 801 requires a secure communication channel with the browser and relies upon a completely separate communication channel to have advertising delivered or other monetization options. Using such a server, it is possible to support an opt-in directory, services specific to the browser, randomizing of advertising results. Advertisements for a web browsing activity are displayed for a subsequent activity, and so forth in order to protect user privacy. Of course, it is also supported to provide the communications of second unsecure communication layer 1002 in a secure fashion that is separate from the communications through first secure communication layer 1001. Data can also be filtered to and from first secure communication layer 1001 and second unsecure communication layer 1002 through filtering tunnel 1003. When obfuscation of demographic data or amalgamation thereof is being used, then secure communication of that data is potentially beneficial. Alternatively, all advertising data and demographic data can be unsecured. Further alternatively, some advertising data and demographic data is unsecured and some advertising data and demographic data is secured. In an embodiment, server 801 serves to request services from the internet 200 requiring cookies. In such a fashion, a user account is created relying a random username and password, a cookie is added to a browsing utility on the server. The server then tracks and supplies cookie information to the service, for example Amazon so that a proper shopping cart is maintainable. Once a purchase is made, the account is deleted as is the cookie and the user data is no longer available. Of course, with Amazon®, the destination shipping address and credit card information are still discernable by Amazon®, to whom they are given, but no tracking of personal information is supported on the user's actual system. In such an embodiment applied to an enterprise, the enterprise provides termination for all user communication paths. Therefore, each message can be unpacked and repacked at the enterprise providing an appearance that all communication terminates at the enterprise, both to the user and to the server or service. This is equally applicable to world wide web traffic as it is to email and other communication. By unpacking all messages at the enterprise, enterprise filtering, logging, and control is enforceable. This is often beneficial to enterprises with sophisticated IT departments. Further, enterprises with multiple locations can package traffic into bundles and transmit secure bundles between locations. Finally, enterprises could employ external anonymized servers to further obfuscate all traffic or at least some traffic from the enterprise.

Referring to FIG. 11, shown is another embodiment showing a computer system communicatively coupled to a wide area network and via the wide area network to a cloud service in the form of cloud storage. Information is stored in a secure storage in the form of a secure cloud storage 900 and sharing of information is performable by storing the information in the secure storage 900 and transmitting a pointer to the information to first secure communication layer 1001 through second unsecure communication layer 1002 through filtering tunnel 1003. Similarly, posting of the information in public spaces on the internet 200 is performed by posting URLs indicating the storage location within the secure storage 900 and permitting access to the secure storage location. For file sharing, the data being shared can be retrieved by the recipient when needed rather than transmitted by the sender. For social media, the social media server need not store all the images, videos, and files uploaded thereto, instead having each individual store their own content locally or within the cloud and then merely retrieve that content on demand. Because the file content is stored securely within the control of the owner of the content, the owner of the content can monitor access, log access, control access and limit access according to known and commonly used processes. Reposting of the same content does not involve re-uploading the content so long as access restrictions allow for formation of a new link to the content or subsequent use of the existing link thereto. If use of the existing link is not permitted, then only the owner of the content can repost said content. As such, the owner maintains more control and greater ability to monitor content. If the secure viewer is required to access the content, in some embodiments cutting, pasting, saving, screen shots, etc. are prohibited and the content remains protected.

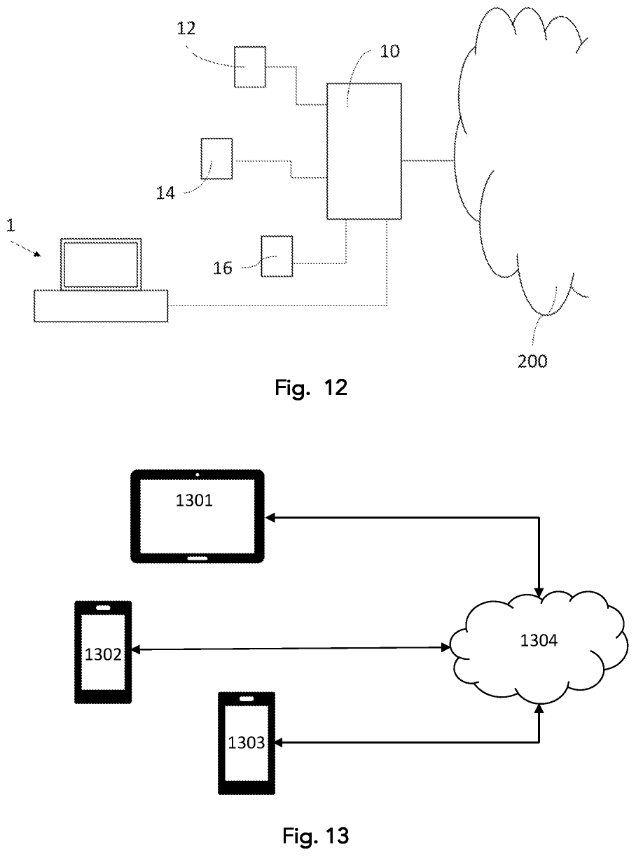

Referring to FIG. 12, shown is a simple gateway 10 relying on a first secure communication layer within a computer system 1 to connect IoT devices 12, 14, 16 to the wide area network in the form of Internet 200 via a secure communication channel. Relying on the privacy enhancement of the above noted embodiments, IoT devices communicate via the Layer 1 communication channel enhancing privacy and security. Advantageously, accessing local IoT devices via a mobile device would form a communication channel with a local computer relying on a first secure communication layer channel and as such is subject to security monitoring and control. In another embodiment, the first secure communication layer channel is provided in a gateway device for IoT devices. Like the above embodiments, when sharing of information is desirable, data transfer is supported by sharing through a parallel unsecure channel. Thus, IoT devices such as those of 12, 14, and 16 can be supported whether legacy, secure, or hybrid in their architectures.

FIG. 13 is a diagram of multiple devices sharing a single profile. The user's main device 1301, and additional devices 1302 and 1303, all contain the application with or connected through the first secure communication layer, software and/or hardware smartcard and associated components. The installation on the user's main device can be enabled to authorize additional devices to the account. The user profile containing policies, certificates, contact and other information can thereby synchronize to the users cloud storage or service 1304. When the application is run from any of the devices a communication channel to the profile located on the cloud storage would be reached. The profile would then be encrypted using the key from the main device and shared with all other devices. Prior to syncing the first secure communication layer of any device, the integrated smart card from that device would authenticate and allow the decryption and transfer to take place.

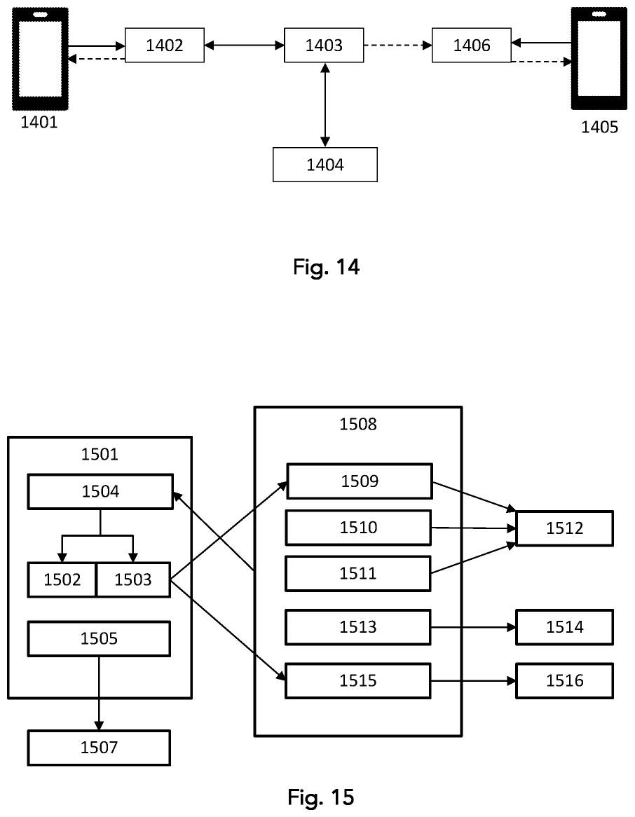

FIG. 14 is a diagram illustrating a peer to peer interaction via an encrypted camera, where User 1 device 1401 is connected to User 1 secure application 1402 and User 2 device 1405 is connected to User 2 secure application 1406. User 1 device has an integrated camera 1403 and the subject of the photograph 1404 is shared to User 1 secure application 1402. Solid arrows in the figure indicate unencrypted data transfer, and broken arrows indicate encrypted data transfer. The present secure application can have an interface to access the device camera. The secure application is capable of bypassing all system OS to the camera, running access only in the application. When a photograph is taken, the application encrypts the photo prior to releasing. When released from the application, the encrypted file can be stored on the phone as an encrypted file, sent to the cloud as an encrypted file (either private or shared), and/or sent directly to a contact in encrypted form using a shared key, or could be encrypted and stored on the users cloud or network drive with a link forwarded to any contact if so desired.

FIG. 15 is an example diagram of contacts and contact groups 1508 within the first secure communication layer 1501 for use in contact access control, secure communication, and other secure features. The smartcard 1504, which can be a software and/or hardware smartcard, validates all actions and releases identity certificates 1502 and contact certificates 1503 as required. The policies 1505 within the user profiles determines the levels of authentication as well as what content and advertising if any would be displayed in the second unsecure communication layer 1507. In one embodiment a user will have several contact groups 1509, 1510, 1511 whose members reside on one routing system 1512. This routing system can dictate regulations and polices for advertising on the second unsecure communication layer 1507, manage subscription services, and using a DNS, blockchain or other method to establish the peer to peer connection. In another embodiment, contact group 1513 and its members wound be managed by a separate routing system 1514. This routing system would dictate regulations and polices for advertising on the second unsecure communication layer 1507, manage subscription services, and using a DNS, blockchain or other method to establish the peer to peer connection. This routing system can be managed by an external organization but maintain compatibility with the communications app in the first communication layer. In another embodiment contact group 1515 and its members can be managed by a separate routing system 1516. This routing system can dictate regulations and polices for advertising on the second unsecure communication layer 1507, manage subscription services, and using a DNS, blockchain or other method to establish the peer to peer connection. This routing system can be managed by an external organization but maintain compatibility with the communications application in the first secure communication layer 1501. In this case, users would be considered to be anonymous but can make use of the verified identity certificate to ensure members are ‘real’ people of required age and location or other required requirements.

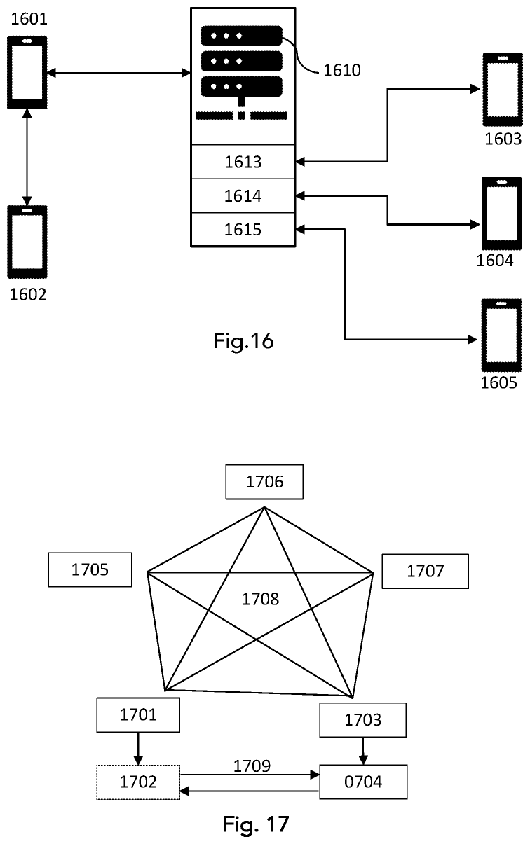

FIG. 16 is a diagram illustrating a peer to multi-peer secure network, where user devices 1601 and 1602 are the devices of stand-alone users, and where user devices 1603, 1604, and 1605 are devices managed on a private network as described. In many corporate and enterprise networks peer to peer solutions cannot work due corporate policy management, need for compliance audit records, and other factors. In response to this a multi-peer gateway software package can be created which can be installed on a client network and act as a go-between between standalone users and managed corporate users. The multi peer gateway server 1610 can translate a ‘peer’ identifier to a corporate identifier then forward the call, message or other action to the user and communicate messages through the gateway via device-specific user gateways 1613, 1614, and 1615, which correspond to and are connected with user devices 1603, 1604, and 1605, respectively. The gateway can then have the ability to enforce policy, create an audit log, and other actions required by the organization. In process, external user device 1601 calls internally managed user device 1604, which as part of an enterprise group is processed by the gateway server. The gateway server adds policy and logging to the communication through user gateway 1614, and forwards to user device 1604.

Multi device access can be enabled across multiple applications and websites, with application, website, and application whitelisting. Preapproval and/or policy based contact creation can also be available. Logging of all actions can be available to one or more master account review, with override of logging where applicable. Logs can also be optionally generated when communicating with law enforcement, child protection agencies, help lines or other actions that may constitute a breach or privacy or could cause additional endangerment to a child. Keyword blocking in messaging, such as names, locations, addresses can also be available to protect minors from inadvertent disclosure of information, and restricted access to the master account stored credit card information can be in place. Further, application mode lock can be applied which prevent minimizing or closing application without master account or other set passwords. In addition, a separate directory system can be provided for main secure application from self-hosted pages, and additional age filters and restrictions options can be available. Group or personal pages can be created in the system to provide only the data desired by the user in accordance with the permissions set by the master account, with each profile optionally encrypted and only viewable by members or a subset of members. Social media style home pages can also be available on the secure network. Further, individual devices and accounts can have imposed time of use restrictions by application or application group as set by the master or parent account.

FIG. 17 is a diagram of a blockchain routing system used to establish a peer to peer connection for communications or content. The blockchain network 1708 with a sampling of consensus nodes 1705, 1706 and 1707 and user nodes 1701 and 1703 located within the first secure communication layer functions as a DNS routing system to create a virtual handshake between users' communications applications 1702 and 1704 where a direct peer to peer connection 1709 can take over. In some embodiments an individual or organization can ‘fork’ the blockchain and create an independent routing system with independent nodes and policies, but still make use of the certificates, identity and security of the communications applications and first communication layer.

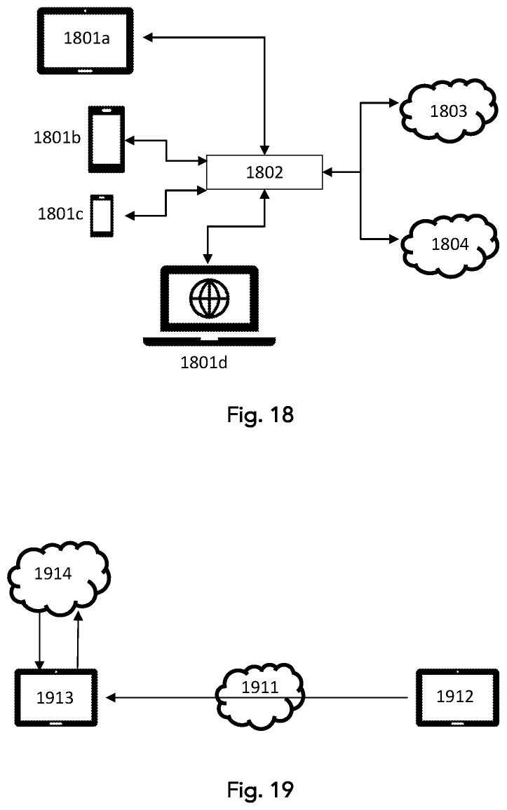

FIG. 18 is a diagram illustrating a parental control with a user cloud profile identifying a family device pool comprising a plurality of devices 1801a, 1801b, 1801c, and 1801d. The user cloud profile 1802 contains details about the devices in the family device pool and security settings of each device, and automatically synchronizes account info with the devices in the family pool. The user cloud profile can also contain sub account policies for each device in the family pool, sub account logs for each device in the family pool, and can contain all contact groups for the plurality of devices in the family pool. Using different passwords can provide multiple layers of access for each device in the family pool. For example, password 1 can access the master account and have access to all contacts and logs, password 2 can be a Child 1 account and have access to Contact Group 1804 with policies enforced, password 3 can provide access to Child 1 account and contact group 4 but have a different set of policies enforced, and password 4 can provide access to Child 1 account and to contact group 1803 with yet a different set of policies enforced. In this way, contact approval can be applied in a layered security system with tailoring to each device and user. A main or parental cloud profile can exist in a family pool alongside one or multiple with sub or child accounts, the cloud profile containing all policies for contact approval. Each device running sub or child profile with policies can be synced with one or more parental accounts such that each sub or child account profile has an approved contact list including allowed web based applications or communication, where communication is freely allowed between internal and external devices meeting all policy requirements can communicate securely, and interactions can be logged to a parent profile. In addition, where communication between internal and external devices does not meet policy the communication can either be denied, or parental approval can be sought which can provide an option for temporary or permanent policy change for the sub or child account.

FIG. 19 is a diagram illustrating a parental control profile governing a child profile. A main or parental cloud profile account 1914 contains a sub or child account. The cloud profile 1914 contains all policies and contact approval for the child account for contact with an external contact 1912. A child device 1913 running a sub or child profile with policies is synced with cloud profile account 1914, and the secure communication network 1911 controls the communication between the child device 1913 and the external contact 1912. The parent ID verified certificate and parent set of user parameters contained in the parental cloud profile account 1914 controls external user meeting and contact requirements. In particular, if the external user is not capable of meeting free contact requirements or the external user is not included in sub or child account profile approved contact list then the secure network will limit or prevent communication and data transfer. Communication is freely allowed between external contact 1912 and child device 1913 meeting all policy requirements.

FIG. 20 is a diagram illustrating secure contact between youth on an online platform 2003, which can be accomplished with a first child device 2001 and second device 2002. The online platform 2003 can be a social media application, game, or any online application where players or users can communicate with one another either privately or publicly. The first child device 2001 is governed by cloud profile 2004 which comprises a Parent ID verified certificate and parent applied set of user parameters. Second device 2002 optionally has its own set of user defined parameters 2005. Preferably, to provide an additional layer of security both users will have confirmed identity and ID in the secure system. In one example, both user parents allow their children to communicate with people in a specified age range and both children are in the range. If Child 1 using first child device 2001 meets the person using second device 2002 in an online game or application and exchange contact requests, if both users meet the other set parameters they will be allowed to exchange contact cards and communicate. Each parent may then optionally receive a profile link to the other parent profile, an ID verification notification (on the other parent), and access to logs of all communications and interactions. A communication layer application programming interface (API) can be made available to allow developers of applications such as online games that can have very young, and much older players on the application. In its current form in most applications people of any age can freely interact. With the present system any person that wishes to communicate with a child would require to be validated by a parent prior. Other settings would allow for registered users to freely communicate within a specified age range in order to keep the social aspect of the applications. With children spending a significant amount of time online often with very little control not only of their actions but the actions and interactions with unknown and unverified persons, the presently described system can include and develop a strategy from the first release to not only protect youth from potential risk but to also limit exposure to advertising and allow parent and guardians greater control of online use and communication.

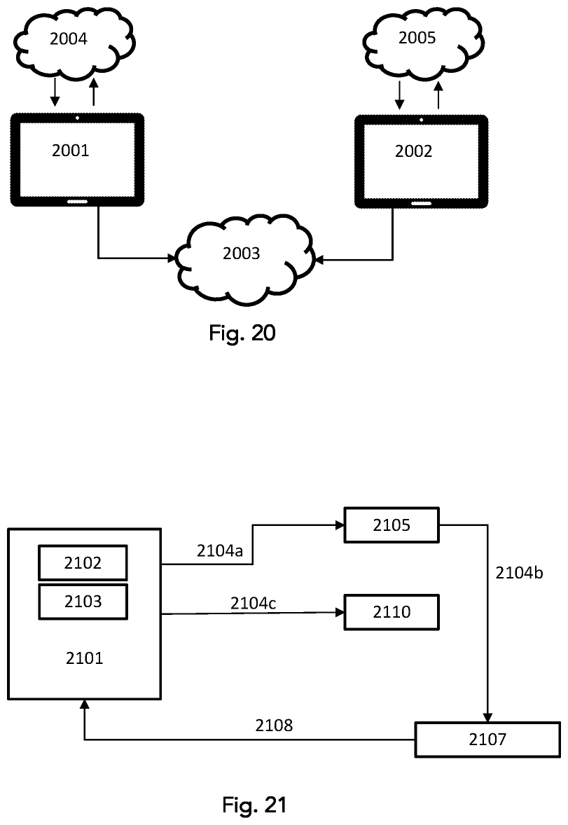

Referring to FIG. 21, shown is a diagram of the process of using a certificate 2102 and the smartcard 2103 from the first secure communications layer 2101 to log on to a website or access online content. Communication link 2104a represents communication between the smartcard and certificates in the first secure communications layer 2101 to the website authentication system 2105. Another communication link 2104b represents the communication between the authentication system and the certificate authority 2107 for any new certificate requirements. Another communication link 2104c represents the communication between the browser and first communication layer and the content or website being accessed. In another embodiment, certificate authority 2107 can release a time based access certificate for users that grants, for example, limited time to view content or on a pay per view basis. In these cases a short duration timed certificate can be issued. In another embodiment the content hosting website can request the verified identity certificate and validate specific authentication requirements. In cases where a website or other content has geographic or age restrictions, the authentication system 2105 can validate the required information in the user's indent validated certificate and either authentic or deny the user access to the content. In the case of content licensing where users use a VPN to circumvent the licence restrictions, the verified identity would not be able to be altered therefore keeping restrictions in place. In the case of mature content that currently is easily accessible by all users or has a simple ‘honour system’ of enter your birthdate to continue, this solution would accurately determine a user true age prior to granting to a site or content. In some embodiments a website or content provider would require the addition of a certificate authority 2107. In such cases, a user would register with the website authentication system 2105 and have a certificate generated and stored as a certificate 2102 via a secure connection 2108 and secured by their smartcard 2103. On future logins the certificate would be verified through a smart card PIN, upon validation communication link 2104c would be a secure connection created to the website or content 2110.

Referring to FIG. 22, shown is a diagram of creating, posting and distributing content from the first communication layer 2201 to a self-hosted or controlled site 2208. Within the first communication layer 2201 the user would be enabled to access a post creation utility 2202 to create the content. The content can be comprised of two parts, a distributable header 2203 and the content main body 2204. When a user completes their content, they can have option to distribute the header through multiple delivery options. An option would be to distribute to an email contact group 2205 or through the communication application within the first communication layer 2201. A user may also have the option to share the content on alternative social media or content sharing sites 2206. The header can also be posted to a central searchable directory system 2207. At the time of post the full post can also be added to the users' main page 2208. In some embodiments a user can enable comments and reactions to comments to some or all posts on their page. In other embodiments a user can have multiple pages with different access controls or policies. In these embodiments controls can be set to limit or control access through the posting users content groups. Alternatively restrictions can be made using the identity verified certificate. In these cases a views may be required to meet location, age or verification status requirements.

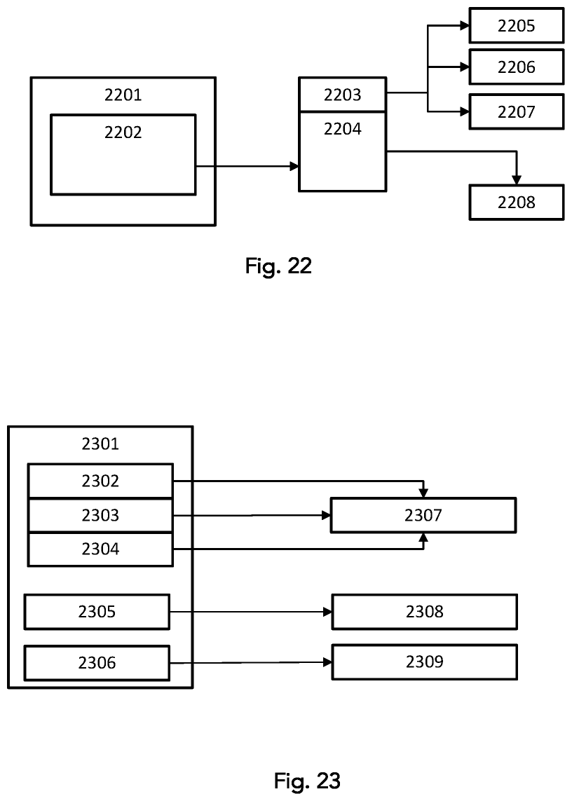

Referring to FIG. 23, shown is a diagram of a post header feed shown in the communication application 2301 in the first communication layer. 2304 through 2306 represent a sampling of post headers from a variety of contacts, with 2302, 2303 and 2304 from contact 1, 2305 from contact 2 and 2306 from contact 3. In one embodiment 2302 through 2304 are open for viewing, comments and reactions. The user clicking on the header in their feed will be directed through the first communication layer to the contacts page where they will be free to view, comment and react. In another embodiment the user clicks on a post header 2305 and directed to contact 2's page where comments are not allowed and the user is free to view but has no options to enter comments or reactions. In another embodiment contact 3 requires age verification to access the specific post. In this case when the user clicks on the header the page will attempt to verify the user's age in their verified identity certificate. If the user meets the requirements they will be able to access the page. In some versions of these embodiments there can be a mix of posts, in these cases each post on the page would follow the rules set during their creation. In the case of contact 1, header 2302 can lead to post that is open and allows comments, header 2303 can lead to a post that does not allow comments and header 2303 can lead to a post that has age requirements. In this case posts with additional requirements will be greyed out to users that do not meet the requirement.

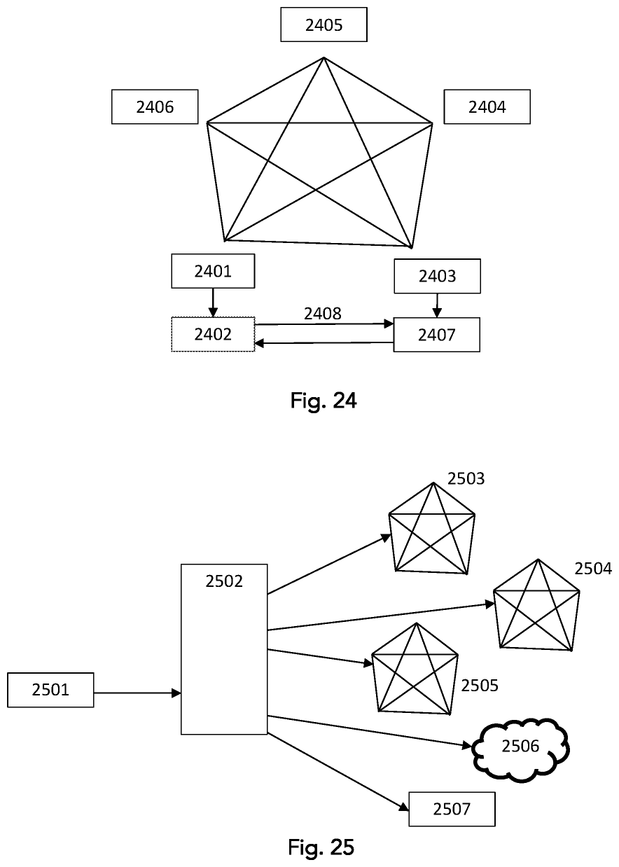

Referring to FIG. 24, shown is a diagram of a blockchain DNS routing system. In some use cases and embodiments a blockchain based DNS routing system 2408 can be used to locate contacts or content on a network and preform a handshake before an internet or peer to peer protocol takes over. In some embodiments the routing system will be used to find contacts and initiate a peer to peer communication session. In these cases a first user 2402 using their contacts list in the first secure communication layer 2401 could select a contact and begin the lookup through the blockchain DNS routing system. The routing system would look up the user through a ledger entry or wallet address location. During this process consensus nodes, a sampling of which represented by 2404, 2405 and 2406 would validate the location of the contact's first layer 2403. Once validated and connected the polices and certificate rules if any would be validated by the first layers. Once validated the first user 2402 would form a peer to peer connection 2408 with the second user 2407, and the blockchain routing system connection would terminate. In another embodiment 2403 can be the location and policies of content or websites and 2407 can be the content. In these cases the process would be the same but the connection would be made to the content.

FIG. 25 is a diagram of a network multi-web. The example shown uses a blockchain routing system to locate and create a peer to peer connection with content. First user 2501 can access multiple networks or internets with varying degrees of privacy settings, access requirements or other requirements through the first communication layer 2502 using the access certificate, identity certificates, privacy and polies associated with this layer. Connection can be made to one or more blockchain DNS networks 2503, 2504 and 2505, the internet 2506, and various peer to peer connections 2507. Each of these networks can exist independent of each other and have their own policies and requirements. In some embodiments age and locations can be required, using the verified identity certificate for each use. In other embodiments such as financial or banking only pages and content associated with that organization would exist on that network, greatly reducing page spoofing or other actions.

Other optional embodiments that can be carried out with the present system include the capability to block all communication attempts from non-verified users or accounts with a return message to sender that this user only accepts messages form verified users. This functionality can be set for only verified users to block ‘troll’ comments and fake negative reviews.

All publications, patents and patent applications mentioned in this specification are indicative of the level of skill of those skilled in the art to which this invention pertains and are herein incorporated by reference. The invention being thus described, it will be obvious that the same may be varied in many ways. Numerous other embodiments may be envisaged without departing from the scope of the invention. Such variations are not to be regarded as a departure from the scope of the invention, and all such modifications as would be obvious to one skilled in the art are intended to be included within the scope of the following claims.

What is claimed is:

1. A system for private communication in a network comprising:
a first secure communication layer comprising private user information;
a first secure communication channel connecting the first secure communication layer with the network;
a second communication layer comprising public user information;
a second communication channel connecting the second communication layer with the network; and
a filtering tunnel between the first secure communication layer and the second communication layer supporting limited and secure communication of selected information between the first secure communication layer and the second communication layer,
wherein the second communication layer has a security setting lower than the security setting of the first secure communication layer.

2. The system of claim 1, wherein the private user information in the first secure communication channel is anonymized by the filtering tunnel during communication of data from the first secure communication layer to the second communication layer.

3. The system of claim 1, wherein the private user information comprises one or more of user identity data, access controls, cryptographic data, cryptographic algorithms, smartcard, policy settings, authentication features, peer to peer communication, email, messages video, text, and other forms of communication between users.

4. The system of claim 1, wherein the public user information comprises one or more of user IP address, cookies, trackers, public user profile, and other public information.

5. The system of claim 1, wherein the first secure communication layer comprises a cryptographic interface.

6. The system of claim 1, wherein each of the first secure communication layer and second communication layer has its own set of security policies and security settings.

7. The system of claim 1, wherein the first communication channel comprises connections to multiple networks having varying privacy and security requirements.

8. The system of claim 1, wherein the private user information comprises one or more user verified certificate, each user verified certificate comprising complete or partial user information.

9. The system of claim 1, wherein the first secure communication layer comprises one or more user verified certificate for a trusted site on the network, the user verified certificate comprising selected private user information required by the trusted site.

10. A method of secure communication with a network comprising:
establishing a first secure communication channel from a first secure communication layer comprising private user information to the network;
establishing a second communication channel from a second communication layer comprising public user information to the network;
anonymizing the private user information and transferring the anonymized private user information from the first secure communication channel to the second communication layer through a filtering tunnel;
sharing the anonymized private information with a site in the network through the second communication channel; and
receiving public information from the network via the second communication channel,
wherein the second communication layer has a security setting lower than the security setting of the first secure communication layer.

11. The method of claim 10, further comprising sharing private user information with a secure site on the network from the first secure communication layer through the first secure communication channel.

12. The method of claim 10, wherein the first secure communication channel communicates with the network through one or more of DNS, IP, blockchain, and other routing and directory services.

13. The method of claim 10, wherein the anonymized private user information is used by the second communication layer to retrieve the received public information, the public information comprising information targeted to the user based on the public user information.

14. The method of claim 10, wherein the private user information comprises one or more of user identity data, access controls, cryptographic data, cryptographic algorithms, smartcard, policy settings, authentication features, peer to peer communication, email, messages video, text, and other forms of communication between users.

15. The method of claim 10, wherein the first secure communication channel uses at least one of a VPN, TOR, a trusted anonymizing web site, and privacy and policy settings.

16. The method of claim 10, wherein the public information comprises user-targeted information based on the public user information.

17. The method of claim 16, wherein the user-targeted information comprises one or more of advertising information, and custom content.

18. The method of claim 17, further comprising reporting the advertising information to the advertiser for tracking and invoicing of advertising performance and revenue.

19. The method of claim 10, further comprising accessing multiple applications simultaneously and separating data streams in secure and unsecure dataflow for the multiple applications while running simultaneously.

20. The method of claim 10, further comprising providing a user verified certificate to a trusted site through the first secure communication channel, the user verified certificate comprising selected private user information required by the trusted site.
